(19) United States
(12) Patent Application Publication
(10) Pub. No.: US 2026/0368618 A1
(43) Pub. Date: Nov. 19, 2026

(54) Training and deploying application-oriented models for targeted operations

(71) Applicant: Bank of America Corporation, Charlotte, NC (US)

(72) Inventors: Ana Maxim, Arlington, VA (US); Manu Kurian, Dallas, TX (US); Michael R. Young, Davidson, NC (US); Freddy A. Cabrera, Matthews, NC (US); Vinesh Premji Patel, London (GB)

(21) Appl. No.: 19/206,675

(22) Filed: May 13, 2025

(51) Int. Cl. G06N 20/00

(52) U.S. Cl. CPC G06N 20/00

(57) ABSTRACT

A system includes a memory storing foundation AI models and a processor coupled to the memory. The processor receives a first request from a first entity system to execute a first task and a first set of training data, loads a first foundation AI model, retrains the first foundation AI using the first set of training data, deploys the retrained first foundation AI model to a first AI agent on the first entity system to execute the first task. The processor receives a second request from a second entity system to execute a second task separate from the first task and a second set of training data, loads a second foundation AI model, retrains the second foundation AI model using the second set of training data, and deploys the retrained second foundation AI model to a second AI agent on the second entity system to execute the second task.

### TECHNICAL FIELD

The present disclosure relates generally to training and deploying models, and more specifically, to training and deploying application-oriented models for targeted operations.

### BACKGROUND

Artificial intelligence (AI) agents are autonomous programs or systems that perceive their environment, process information, and take actions to achieve specific goals. AI agents can range from simple rule-based bots to complex machine learning models that adapt to changing conditions.

### SUMMARY

Conventional systems for task executions often rely on a single model trained on a limited training set for a specific task, leading to significant drawbacks with negative consequences. Training a single model on a limited training set is prone to biases due to inadequately vetted training data. When such a model is used for specialized tasks, it frequently misinterprets nuances, deviations, or domain-specific changes, resulting in incorrect task execution. Such errors can cause system crashes, prolonged processing delays, or excessive consumption of computational resources, which in turn slows down other tasks and degrades overall system performance. Additionally, when multiple models are executing, conventional systems lack effective resource allocation. For example, multiple models may redundantly process the same data, further straining resources. This inefficiency not only wastes computing power but also compromises processing speed and the accuracy of execution results, ultimately undermining the system's reliability and effectiveness.

The system disclosed in the present application provides a technical solution to the problems discussed above. The disclosed system trains and deploys task-specific AI models to entity systems as AI agents. Upon receiving a request from an entity system for executing a task, the disclosed system determines which pre-trained foundation AI model is suitable for the task and selects the suitable foundation AI model. The disclosed system further retrains the foundation AI model using training data provided by the entity system. Such training data is specialized for the task. The disclosed system then deploys the retrained AI model to an AI agent executing on the entity system to execute the task.

In one embodiment, the disclosed system includes a memory operable to store a plurality of foundation artificial intelligence (AI) models. The disclosed system further includes a processor operably coupled to the memory. The processor is configured to receive, from a first entity system, a first request to execute a first task and a first set of training data associated with the first task. The first set of training data includes data samples related to the first task and their respective labels categorizing the data samples with respect to the first task. The processor is further configured to load from the memory a first foundation AI model from among the plurality of foundation AI models based at least in part upon first task metadata of the first task. The first task metadata includes at least a first detailed description of the first task, a first parameter of the first task, and a first type of the first task. The first foundation AI model is selected based on the first task metadata. The first foundation AI model was trained to execute tasks of the first type and includes a plurality of first model parameters. The processor is further configured to retrain the first foundation AI model by updating the plurality of first model parameters based at least in part upon the first set of training data. The processor is further configured to deploy the retrained first foundation AI model to a first AI agent executing on the first entity system to execute the first task. The processor is further configured to receive, from a second entity system, a second request to execute a second task separate from the first task and a second set of training data associated with the second task. The second set of training data includes data samples related to the second task and their respective labels categorizing the data samples with respect to the second task. The processor is further configured to load from the memory a second foundation AI model from among the plurality of foundation AI models based at least in part upon second task metadata of the second task. The second task metadata includes at least a second detailed description of the second task, a second parameter of the second task, and a second type of the second task. The second foundation AI model is selected based on the second task metadata. The second foundation AI model was trained to execute tasks of the second type and includes a plurality of second model parameters. The processor is further configured to retrain the second foundation AI model by updating the plurality of second model parameters based at least in part upon the second set of training data. The processor is further configured to deploy the retrained second foundation AI model to a second AI agent executing on the second entity system to execute the second task.

In one embodiment, the processor is further configured to determine that executing the first task requires executing a third task by a third AI agent executing on the first entity system. The processor is further configured to access, from the first entity system, a third set of training data associated with the third task. The processor is further configured to load from the memory a third foundation AI model from among the plurality of foundation AI models based at least in part upon third task metadata of the third task. The third task metadata includes at least a third detailed description of the third task, a third parameter of the third task, and a third type of the third task. The third foundation AI model was trained to execute tasks associated with the third type and includes a plurality of third model parameters. The processor is further configured to retrain the third foundation AI model by updating the plurality of third model parameters based at least in part upon the third set of training data. The processor is further configured to deploy the retrained third foundation AI model to the third AI agent to execute the third task.

In one embodiment, the third AI agent is configured to execute the third task using execution results of the first task by the first AI agent.

In one embodiment, the processor is further configured to determine that the first task requires a sub-task requiring a third AI agent executing on the first entity system. The processor is further configured to load from the memory a third foundation AI model from among the plurality of foundation AI models based at least in part upon task metadata of the sub-task. The task metadata includes a detailed description of the sub-task, a parameter of the sub-task, and a type of the sub-task. The third foundation AI model was trained to execute tasks of the type associated with the sub-task and includes a plurality of third model parameters. The processor is further configured to retrain the third foundation AI model by updating the plurality of third model parameters based at least in part upon the first set of training data. The processor is further configured to deploy the retrained third foundation AI model to the third AI agent to execute the sub-task.

In one embodiment, the system further includes a plurality of application programming interfaces (APIs). Receiving the first request or deploying the retrained first foundation AI model to the first AI agent is via a first API among the plurality of APIs. Receiving the second request or deploying the retrained second foundation AI model to the second AI agent is via a second API among the plurality of APIs.

In one embodiment, the processor is further configured to receive, from the first entity system, execution results of the first task by the first AI agent. The processor is further configured to determine a performance of the first AI agent does not meet one or more criteria based on the execution results. The processor is further configured to load from the memory at least a third foundation AI model and a fourth foundation AI model from among the plurality of foundation AI models based at least in part upon the first task metadata. The processor is further configured to retrain the third foundation AI model based at least in part upon the first set of training data. The processor is further configured to retrain the fourth foundation AI model based at least in part upon the first set of training data. The processor is further configured to deploy the retrained third foundation AI model to a third AI agent executing on the first entity system and the retrained fourth foundation AI model to a fourth AI agent executing on the first entity system to execute the first task respectively. The first AI agent, third AI agent, and fourth AI agent use a consensus mechanism to finalize execution results of the first task.

In one embodiment, the processor is further configured to receive, from the first entity system, execution results of the first task by the first AI agent. The processor is further configured to determine a performance of the first AI agent does not meet one or more criteria based on the execution results. The processor is further configured to deactivate the first AI agent from executing on the first entity system.

The disclosed system and methods provide the practical application of training and deploying task-specific AI models to AI agents executing on entity systems to execute different tasks. Conventional systems rely on a single model trained on a limited training set for a specific task, leading to incorrect task execution which can cause system crashes, prolonged processing delays, or excessive consumption of computational resources. In addition, multiple models may redundantly process the same data, which not only wastes computing power but also compromises processing speed and the accuracy of execution results. The disclosed system and methods can address such problems by training and deploying task-specific AI models to entity systems as AI agents to execute tasks. As described in example embodiments of the present disclosure, the disclosed system and methods analyze a task execution request from an entity system to select a foundation AI model that is suitable for the task, retrain the selected foundation AI model using task-specialized training data provided by the entity system, and then deploy the retrained AI model to an AI agent executing on the entity system to execute the task. Retraining a pre-trained foundation AI model using task-specialized training data can reduce biases as the foundation AI model was pre-trained on a wider range of task related data and the task-specialized training data can finetune the pre-trained foundation AI model to excel in the dedicated task. In addition, small and specialized task-specific AI models execute faster as they perform fewer computations. Deploying dedicated AI models trained for specific tasks as AI agents can improve resource allocation as each AI agent focuses on a specific task so that multiple AI agents would not waste computational resources on redundant tasks.

Technical advantages of certain embodiments of this disclosure may include one or more of the following. The disclosed system and methods can enable accurate task executions by leveraging specialized AI agents. For example, the specialized AI agents are based on AI models that are trained using task-specialized training data to avoid biases, misinterpretations, or data overload often seen in general-knowledge AI models trained on broad, diverse data. As another example, through finetuning foundation AI models using task-specialized training data, the AI agents can effectively detect deviations, improve fault tolerances, and be robust against system noise, ensuring accurate task execution. By delivering accurate task execution results, the disclosed system and methods can further prevent system crashes, reduce processing delays, or reduce consumption of computational resources. For example, accurate task execution results can constrain system behavior within valid operational boundaries, reduce exception conditions, and maintain coherence across pipeline stages, which collectively prevents system crashes. As another example, accurate task execution results can reduce processing delays by minimizing error-handling overhead, decreasing control-flow divergence, enabling early termination of redundant stages, and preventing dependency-induced bottlenecks in downstream processing. As yet another example, accurate task execution results can minimize the need for corrective computation, auxiliary model invocation, and intermediate data inflation, which leads to reduced CPU utilization, lower memory consumption, and more efficient dataflow across the processing pipeline. The disclosed system and methods can optimize resource allocation. For example, the disclosed system and methods deploy dedicated AI models trained for specific tasks as AI agents. As such, each AI agent focuses on a specific task so that when multiple AI agents are executing, they would not waste computational resources on redundant tasks. As another example, when a task involves multiple sub-tasks, the disclosed system and methods enable a coordinated deployment of AI agents (e.g., a respective AI agent for executing each sub-task), combining their capabilities to complete the task efficiently and reliably, maximizing performance while minimizing computational waste.

Certain embodiments of the present disclosure may include some, all, or none of these advantages. These advantages and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates one embodiment of a system that is configured for training and deploying application-oriented models for targeted operations.

FIGS. 2A-2D illustrate an example flowchart of a method for training and deploying application-oriented models for targeted operations.

### DETAILED DESCRIPTION

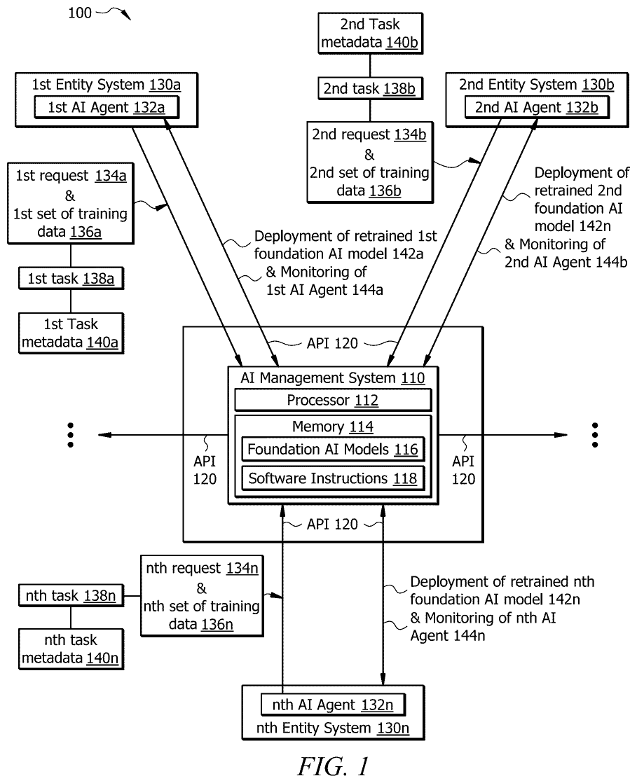

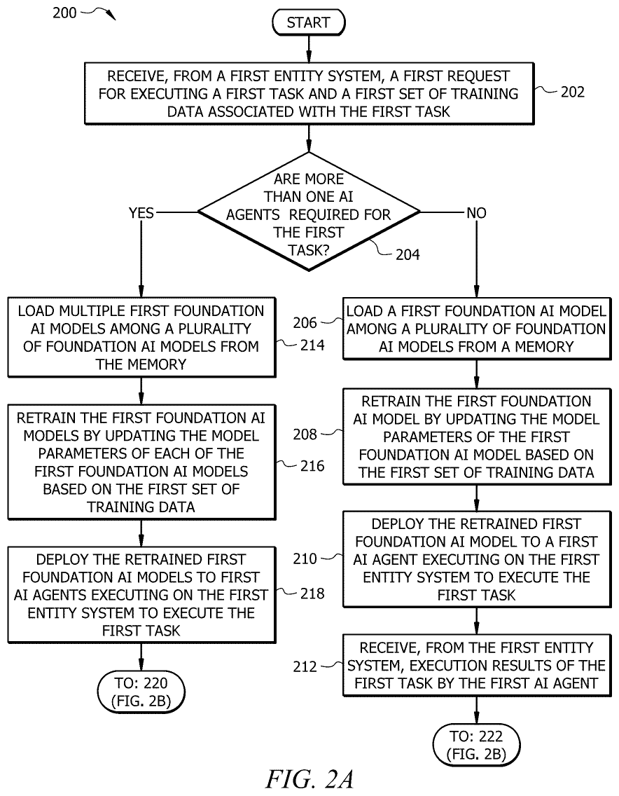

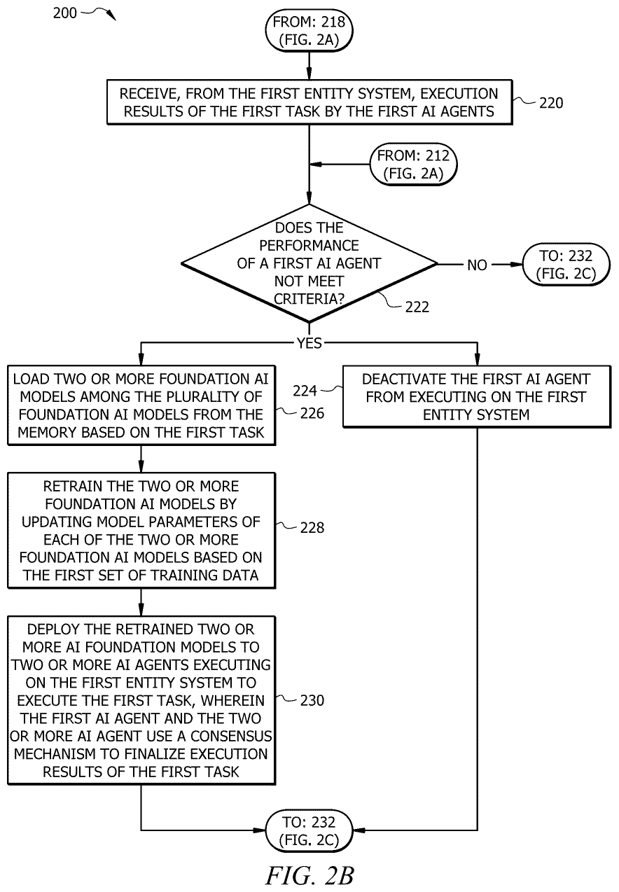

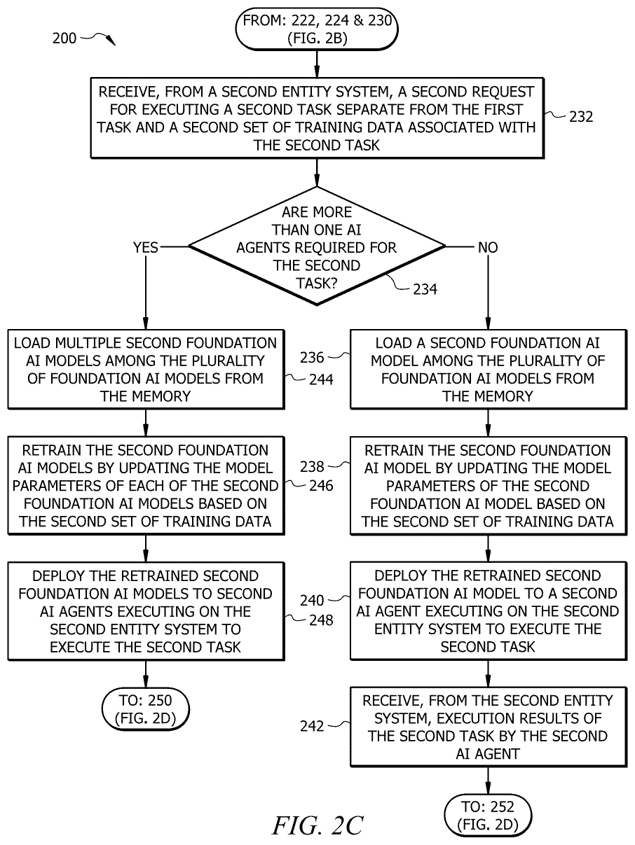

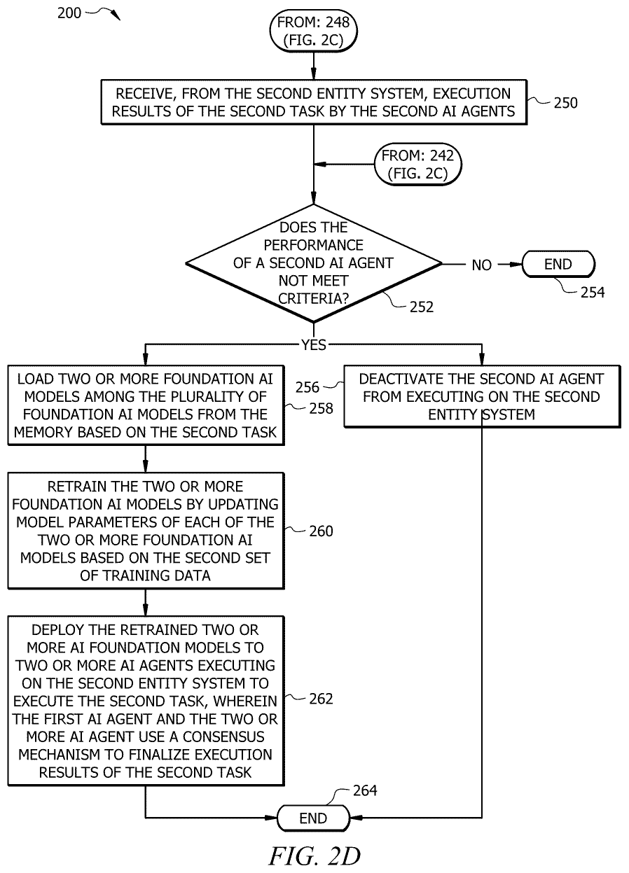

As described above, conventional systems may build more extensive and more complex AI models, which require massive amounts of data, computational resources, and time to train. This disclosure provides various systems and methods to utilize smaller, more specialized AI models, particularly in the context of multi-modal frameworks, which improves the utilization of computing resources and security. FIG. 1 illustrates one embodiment of a system that is configured for training and deploying application-oriented models for targeted operations. FIGS. 2A-2B illustrate an example flowchart of a method for training and deploying application-oriented models for targeted operations.

### Example System for Training and Deploying Application-Oriented Models for Targeted Operations

FIG. 1 illustrates one embodiment of a system 100 that is configured for training and deploying application-oriented models for targeted operations. System 100 comprises an AI management system 110 and a plurality of entity systems 130. In some embodiments, system 100 may not have all of the components listed and/or may have other elements instead of, or in addition to, those listed above.

### Architecture Components

### Entity System

Entity system 130 is generally any device that is configured to process data and communicate with devices, systems (e.g., AI management system 110), etc. Entity system 130 is generally configured to execute an AI agent 132. For example, the first entity system 130a is configured to execute the first AI agent 132a; the second entity system 130b is configured to execute the second AI agent 132b; and the nth entity system 130n is configured to execute the nth AI agent 132n.

An AI agent 132 is an AI software designed to operate with autonomy and goal-directed behavior. The AI agent 132 may act on behalf of a user or organization associated with the entity system 130. The AI agent 132 may perceive its environment, process data, and take actions to achieve specific objectives. For example, an AI agent 132 may perform security checks to identify vulnerabilities of the entity system 130. As another example, an AI agent 132 may be capable of reviewing documents. As yet another example, an AI agent 132 may be able to build prototypes of applications. As yet another example, an AI agent 132 may conduct research, gather research data, and analyze the gathered data.

### AI Management System

AI management system 110 is generally any device that is configured to process data and communicate with devices, systems (e.g., entity system 130), etc. AI management system 110 is generally configured to perform operations described further below in conjunction with method 200 described in FIGS. 2A-2B. In an embodiment, AI management system 110 comprises one or more processors 112 in signal communication with a memory 114.

Processors 112 are operably coupled to the memory 114. A processor 112 is any electronic circuitry, including, but not limited to, state machines, one or more central processing unit (CPU) chips, logic units, cores (e.g., a multi-core processor), field-programmable gate arrays (FPGAs), application-specific integrated circuits (ASICs), or digital signal processors (DSPs). A processor 112 may be a programmable logic device, a microcontroller, a microprocessor, or any suitable combination of the preceding. Processors 112 are communicatively coupled to and in signal communication with memory 114. Processors 112 are configured to process data. For example, a processor 112 may be 8-bit, 16-bit, 32-bit, 64-bit or of any other suitable architecture. A processor 112 may include an arithmetic logic unit (ALU) for performing arithmetic and logic operations, processors register that supply operands to the ALU and store the results of ALU operations, and a control unit that fetches software instructions 118 from memory 114 and execute them by directing the coordinated operations of the ALU, registers and other components. Processors 112 are configured to implement various software instructions 118. For example, processors 112 are configured to execute software instructions 118 to implement the functions disclosed herein, such as some or all of those described with respect to FIGS. 1-2. In some embodiments, the function described herein is implemented using logic units, FPGAs, ASICs, DSPs, or any other suitable hardware or electronic circuitry.

Memory 114 may be volatile or non-volatile and may comprise a read-only memory (ROM), random-access memory (RAM), ternary content-addressable memory (TCAM), dynamic random-access memory (DRAM), and static random-access memory (SRAM). Memory 114 may be implemented using one or more disks, tape drives, solid-state drives, and/or the like. Memory 114 is operable to store the software (e.g., foundation AI models 116), and/or any other data or software instructions 118.

Foundation AI models 116 may be pre-trained models. In an embodiment, foundation models may include generative AI models such as a large language model. Foundation AI models 116 may also include task-specific model. For example, a task-specific model may be programmed to detect malicious communications. Foundation AI models 116 can be trained on training datasets comprising a plurality of training data using appropriate algorithms. The training data may be labeled as different task categories. To generate the training data, AI management system 110 may collect historical task execution data, logs from entity systems 130, and user feedback. AI management system 110 may annotate the collected data. AI management system 110 may preprocess the collected data. For example, AI management system 110 may clean records, remove duplicates, and format the collected data for analysis. Once the training data are generated, AI management system 110 may train foundation AI models 116. Each trained foundation AI model may be suitable for a set of tasks 138.

Software instructions 118 may comprise any suitable set of instructions, logic, rules, or code operable to execute processors 112. Software instructions 118, when executed by processors 112, cause processors 112 to perform one or more functions described herein. For example, when software instructions 118 are executed, processors 112 execute select a foundation AI model 116 for a task 138 requested by an entity system 130. When software instructions 118 are executed, processors 112 further retrain the selected foundation AI model 116 based on the set of training data 136 provided by the entity system 130. When software instructions 118 are executed, processors 112 further deploy the retrained foundation AI model 116 to the AI agent 132 executing on the entity system 130.

### Application Programming Interfaces (APIs)

AI management system 110 may communicate with entity systems 130 via a plurality of application programming interfaces (APIs) 120. Each of the APIs 120 includes a predefined set of instructions that are intended to provide a communication path (by acting as a middleman) between AI management system 110 and entity systems 130. In general, entity systems 130 utilize application programming interface (API) calls (e.g., a request or a command) that may invoke one or more functions supported by AI management system 110, for example, to deploy a retrained foundation AI model 116 to an AI agent 132. For example, API 120 is configured to receive a request 134 and a set of training data 136 associated with the request 134. API 120 is configured to fulfill the deployment 142 of the retrained foundation AI model 116 to the AI agent 132. Further, API 120 is configured to transmit data associated with the monitoring 144 of the AI agent 132.

In some examples, the API calls may include a hypertext transfer protocol get request, a hypertext transfer protocol put request, a key-value store command, a messaging call, a queuing call, a remote storage call, a delivery to a content delivery network request, a management command to a content delivery network, or the like.

### Operational Flow

In an embodiment, entity system 130 may send a request 134 associated with a task 138 to AI management system 110. Entity system 130 may also send a set of training data 136 that are specialized for that task 138. For example, first entity system 130a may send a first request 134a and a first set of training data 136a associated with a first task 138a to AI mangement system 110. The first task 138a may be identifying security vulnerabilities of the first entity system 130a. The first set of training data 136a includes data samples related to the first task 138a and their respective labels categorizing the data samples with respect to the first task 138a. Second entity system 130b may send a second request 134b and a second set of training data 136b associated with a second task 138b to AI mangement system 110. The first task 138a may be detecting malicious communications to the second entity system 130b. The second set of training data 136b includes data samples related to the second task 138b and their respective labels categorizing the data samples with respect to the second task 138b. Nth entity system 130n may send an nth request 134n and an nth set of training data 136n associated with an nth task 138n to AI mangement system 110. The nth set of training data 136n includes data samples related to the nth task 138n and their respective labels categorizing the data samples with respect to the nth task 138n.

When AI management system 110 receives request 134, AI management system 110 may analyze the task metadata 140 associated with the task 138. In an embodiment, task metadata 140 includes at least a detailed description of the task 138, a parameter of the task 138, and a type of the task 138. For example, the first task metadata 140a at least a first detailed description of the first task 138a, a first parameter of the first task 138a, and a first type of the first task 138a. The second task metadata 140b includes at least a second detailed description of the second task 138b, a second parameter of the second task 138b, and a second type of the second task 138b. The nth task metadata 140n at least an nth detailed description of the nth task 138n, an nth parameter of the nth task 138n, and an nth type of the nth task 138n.

Based on the analysis, AI management system 110 may determine which foundation AI model 116 to load from memory 114. For example, a foundation AI model 116 pre-trained for image generation may be selected for a task 138 of logo generation. In an embodiment, AI management system 110 may load a first foundation AI model 116a trained to execute tasks of the first type. The first foundation AI model 116a includes a plurality of first model parameters. AI management system 110 may load a second foundation AI model 116b trained to execute tasks of the second type. The second foundation AI model 116b includes a plurality of second model parameters. AI management system 110 may load an nth foundation AI model 116n trained to execute tasks of the nth type. The nth foundation AI model 116n includes a plurality of nth model parameters.

AI management system 110 further finetunes the loaded foundation AI model 116. In an embodiment, AI management system 110 retrains the loaded foundation AI model 116 by updating its model parameters using the set of training data 136 provided by entity system 130. For example, AI management system 110 retrains the first foundation AI model 116a by updating the first model parameters based on the first set of training data 136a, the second foundation AI model 116b by updating the second model parameters based on the second set of training data 136b, and the nth foundation AI model 116n by updating the nth model parameters based on the nth set of training data 136n.

Once the loaded foundation AI model 116 is finetuned/retrained, AI management system 110 deploys 142 it to the AI agent 132 executing on the entity system 130 that requested the task 138. For example, AI management system 110 deploys 142a the retrained first foundation AI model to the first AI agent 132a executing on the first entity system 130a to execute the first task 138a. AI management system 110 deploys 142b the retrained second foundation AI model to the second AI agent 132b executing on the second entity system 130b to execute the second task 138b. AI management system 110 deploys 142n the retrained nth foundation AI model to the nth AI agent 132n executing on the nth entity system 130n to execute the nth task 138n.

In an embodiment, AI management system 110 may determine that executing a task 138 requires executing another task 138 by another AI agent 132 executing on the entity system 130. For example, executing a task 138 of document generation may require executing another task 138 of validating the generated document. AI management system 110 may then load and retrain another foundation AI model 116 for the additionally required AI agent 132 and deploy the retrained foundation AI model 116 to that AI agent 132. For example, AI management system 110 determines that executing the first task 138a requires executing a third task 138c by a third AI agent 132c executing on the first entity system 130a. AI management system 110 accesses, from the first entity system 130a, a third set of training data 136c associated with the third task 138c. AI management system 110 then loads a third foundation AI model 116c based on third task metadata 140c of the third task 138c. The third foundation AI model 116c was trained to execute tasks associated with the third type and includes a plurality of third model parameters. AI management system 110 then retrains the third foundation AI model 116c by updating the third model parameters based on the third set of training data 136c and deploys the retrained third foundation AI model to the third AI agent 132c to execute the third task 138c. In an embodiment, the third AI agent 132c may be configured to execute the third task 138c using execution results of the first task 138a by the first AI agent 132a.

In an embodiment, AI management system 110 may determine that executing a task 138 requires executing a sub-task by another AI agent 132 executing on the entity system 130. AI management system 110 may then load and retrain another foundation AI model 116 for the additionally required AI agent 132 and deploy the retrained foundation AI model 116 to that AI agent 132. For example, AI management system 110 determines that the first task 138a requires a sub-task requiring a third AI agent 132c executing on the first entity system 130a. AI management system then loads a third foundation AI model 116c based on task metadata 140 of the sub-task. The task metadata 140 includes a detailed description of the sub-task, a parameter of the sub-task, and a type of the sub-task. The third foundation AI model 116c was trained to execute tasks of the type associated with the sub-task and includes a plurality of third model parameters. AI management system 110 then retrains the third foundation AI model 116c by updating the plurality of third model parameters based on the first set of training data 136a and deploys the retrained third foundation AI model to the third AI agent 132c to execute the sub-task. Although this disclosure describes one sub-task for a task 138, this disclosure contemplates any suitable number of sub-tasks for a task 138. For example, executing a task 138 requires executing a plurality of sub-tasks by a plurality of other AI agents 132 executing on the entity system 130. AI management system 110 may then load and retrain a plurality of other foundation AI models 116 for the additionally required AI agents 132 and deploy the retrained foundation AI models 116 to those AI agents 132.

To ensure the performance, AI management system 110 may monitor 144 the task executions by AI agents 132. If the performance of an AI agent 132 does not meet the criteria, AI management system 110 may either deactivate the AI agent 132 or get more AI agents to execute the task using a consensus mechanism. As one example, AI management system 110 receives execution results of the first task 138a by the first AI agent 132a from the first entity system 130a. AI management system 110 determines the performance of the first AI agent 132a does not meet one or more criteria based on the execution results. Accordingly, AI management system 110 may deactivate the first AI agent 132a from executing on the first entity system 130a.

As another example, AI management system 110 receives execution results of the first task 138a by the first AI agent 132a from the first entity system 130a. AI management system 110 determines the performance of the first AI agent 132a does not meet one or more criteria based on the execution results. Accordingly, AI management system 110 may load at least a third foundation AI model 116c and a fourth foundation AI model 116d based on the first task metadata 140a. AI management system 110 may retrain the third foundation AI model 116c and the fourth foundation AI model 116d based on the first set of training data 136a. AI management system 110 may further deploy the retrained third foundation AI model to a third AI agent 132c executing on the first entity system 130a and the retrained fourth foundation AI model to a fourth AI agent 132d executing on the first entity system 130a to execute the first task 138a respectively. In an embodiment, the first AI agent 132a, third AI agent 132c, and fourth AI agent 132d use a consensus mechanism to finalize execution results of the first task 138a.

### Example Methods for Training and Deploying Application-Oriented Models for Targeted Operations

FIGS. 2A-2D illustrate an example flowchart of a method 200 for training and deploying application-oriented models for targeted operations. Modifications, additions, or omissions may be made to method 200. Method 200 may include more, fewer, or other operations. For example, operations may be performed in parallel or in any suitable order. While at times discussed as AI management system 110, or components of any of thereof performing operations, any suitable system or components of the system may perform one or more operations of the method 200. For example, one or more operations of method 200 may be implemented, at least in part, in the form of software instructions (e.g., software instructions 118 of FIG. 1), stored on non-transitory, tangible, machine-readable media (e.g., memory 114 of FIG. 1) that when run by one or more processors (e.g., processors 112 of FIG. 1) may cause the one or more processors to perform operations 202-264.

After start, AI management system 110 receives, from a first entity system 130a, a first request 134a for executing a first task 138a and a first set of training data 136a associated with the first task 138a at operation 202. For example, the first task 138a may be document generation. As another example, the first task 138a may be conducting research on a topic. The first request 134a may be accompanied with a first set of training data 136a specialized for the first task 138a. The first set of training data 136a may include data samples related to the first task 138a and their respective labels categorizing the data samples with respect to the first task 138a. For example, for the task 138 of document generation, the first set of training data 136a may include sample documents and their categories such as account summary, investment summary, etc. The first request 134a and the first set of training data 136a may be received via an API 120 associated with AI management system 110.

At operation 204, AI management system 110 determines whether more than one AI agent 132 are required for the first task 138a. For example, the task 138 of document generation may require an AI agent 132 for generating a document and another AI agent 132 for validating the generated document. If not more than one AI agent 132 are required, method 200 proceeds to operation 206.

At operation 206, AI management system 110 loads a first foundation AI model 116a among a plurality of foundation AI models 116 from a memory 114. In an embodiment, AI management system 110 may identify the first foundation AI model 116a is suitable for the first task 138a by analyzing the first task metadata 140a associated with the first task 138a. The first task metadata 140a includes at least a detailed description of the first task 138a, a parameter of the first task 138a, and a type of the first task 138a. In an embodiment, AI management system 110 may determine the first foundation AI model 116a is suitable for the first task 138a based on the type of the first task 138a. For example, for the task 138 of logo generation, a foundation AI model 116 that was pre-trained for image generation may be loaded from the memory 114.

At operation 208, AI management system 110 retrains the first foundation AI model 116a by updating the model parameters of the first foundation AI model 116a based on the first set of training data 136a. For example, the first foundation AI model 116a may be a pre-trained neural network model having a plurality of model parameters. By retraining the first foundation AI model 116a using the first set of training data 136a, the model parameters of the neural network model can be updated so that the retrained foundation AI model is more specialized for the first task 138a.

At operation 210, AI management system 110 deploys the retrained first foundation AI model to a first AI agent 132a executing on the first entity system 130a to execute the first task 138a. The deployment of the retrained first foundation AI model may be via an API 120 associated with AI management system 110. Upon deployment, AI management system 110 may monitor the task execution by the first AI agent 132a.

At operation 212, AI management system 110 receives, from the first entity system 130a, execution results of the first task 138a by the first AI agent 132a. The execution results may be received via an API 120 associated with AI management system 110. Method 200 then proceeds to operation 222.

If more than one AI agent 132 are required at operation 204, method 200 proceeds to operation 214. For example, the first task 138a may involve several sub-tasks, and multiple AI agents 132 may be required for executing the sub-tasks.

At operation 214, AI management system 110 loads multiple first foundation AI models 116a among a plurality of foundation AI models 116 from the memory 114. In an embodiment, AI management system 110 may identify the multiple first foundation AI models 116a are required for the first task 138a by analyzing the first task metadata 140a associated with the first task 138a. For example, AI management system 110 may determine the multiple first foundation AI models 116a are required for the first task 138a based on the detailed description of the first task 138a.

At operation 216, AI management system 110 retrains the first foundation AI models 116a by updating the model parameters of each of the first foundation AI models 116a based on the first set of training data 136a.

At operation 218, AI management system 110 deploys the retrained first foundation AI models to first AI agents 132a executing on the first entity system 130a to execute the first task 138a. For example, these first AI agents 132a may execute their respective sub-tasks to complete the execution of the first task 138a. Upon deployment, AI management system 110 may monitor the task executions by the first AI agents 132a. The deployment of these retrained first foundation AI models may be via one or more APIs 120 associated with AI management system 110.

At operation 220, AI management system 110 receives, from the first entity system 130a, execution results of the first task 138a by the first AI agents 132a. The execution results may be received via one or more APIs 120 associated with AI management system 110. Method 200 then proceeds to operation 222.

At operation 222, AI management system 110 determines whether the performance of the first AI agent 132a (if only one AI agent 132 is required) or any first AI agent 132a (if more than one AI agent 132 are required) does not meet criteria. For example, the criteria may include accuracy of task execution results.

If the performance of the first AI agent 132a (if only one AI agent 132 is required) or all first AI agents 132a (if more than one AI agent 132 are required) meets the criteria, e.g., the accuracy of task execution results is acceptable, method 200 proceeds to operation 232.

If the performance of the first AI agent 132a (if only one AI agent 132 is required) or any first AI agent 132a (if more than one AI agent 132 are required) does not meet criteria, e.g., the accuracy of task execution results is unacceptable, method 200 may proceed two separate operation flows.

In one operation flow, at operation 224, AI management system 110 deactivates the first AI agent 132a from executing on the first entity system 130a. Method 200 then proceeds to operation 232.

In another operation flow, at operation 226, AI management system 110 loads two or more foundation AI models 116 among the plurality of foundation AI models 116 from the memory 114 based on the first task 138a. These two or more foundation AI models 116 would enable a coordinated execution of the first task 138a by multiple AI agents 132 based on a consensus mechanism.

At operation 228, AI management system 110 retrains the two or more foundation AI models 116 by updating model parameters of each of the two or more foundation AI models 116 based on the first set of training data 136a.

At operation 230, AI management system 110 deploys the retrained two or more AI foundation models 116 to two or more AI agents 132 executing on the first entity system 130a to execute the first task 138a. The deployment may be via one or more APIs 120 associated with AI management system 110. The first AI agent 132a and the two or more AI agents 132 may use a consensus mechanism to finalize execution results of the first task 138a. For example, the execution result that has the most consensus among these AI agents 132 may be used as the final execution result for the first task 138a. Method 200 then proceeds to operation 232.

At operation 232, AI management system 110 receives, from a second entity system 130b, a second request 134b for executing a second task 138b separate from the first task 138a and a second set of training data 136b associated with the second task 138b. For example, the second task 138b may be identifying security vulnerabilities. The second request 134b and the second set of training data 136b may be received via an API 120 associated with AI management system 110.

At operation 234, AI management system 110 determines whether more than one AI agent 132 are required for the second task 138b. If not more than one AI agent 132 are required, method 200 proceeds to operation 236.

At operation 236, AI management system 110 loads a second foundation AI model 116b among the plurality of foundation AI models 116 from the memory 114. In an embodiment, AI management system 110 may identify the second foundation AI model 116b is suitable for the second task 138b by analyzing the second task metadata 140b associated with the second task 138b. The second task metadata 140b includes at least a detailed description of the second task 138b, a parameter of the second task 138b, and a type of the second task 138b. In an embodiment, AI management system 110 may determine the second foundation AI model 116b is suitable for the second task 138b based on the type of the second task 138b.

At operation 238, AI management system 110 retrains the second foundation AI model 116b by updating the model parameters of the second foundation AI model 116b based on the second set of training data 136b.

At operation 240, AI management system 110 deploys the retrained second foundation AI model to a second AI agent 132b executing on the second entity system 130b to execute the second task 138b. The deployment of the retrained second foundation AI model may be via an API 120 associated with AI management system 110. Upon deployment, AI management system 110 may monitor the task execution by the second AI agent 132b.

At operation 242, AI management system 110 receives, from the second entity system 130b, execution results of the second task 138b by the second AI agent 132b. Method 200 then proceeds to operation 252. The execution results may be received via an API 120 associated with AI management system 110.

If more than one AI agent 132 are required at operation 234, method 200 proceeds to operation 244. For example, the second task 138b may involve several sub-tasks, and multiple AI agents 132 may be required for executing the sub-tasks.

At operation 244, AI management system 110 loads multiple second foundation AI models 116b among the plurality of foundation AI models 116 from the memory 114. In an embodiment, AI management system 110 may identify the multiple second foundation AI models 116b are required for the second task 138b by analyzing the second task metadata 140b associated with the second task 138b. For example, AI management system 110 may determine the multiple second foundation AI models 116b are required for the second task 138b based on the detailed description of the second task 138b.

At operation 246, AI management system 110 retrains the second foundation AI models 116b by updating the model parameters of each of the second foundation AI models 116b based on the second set of training data 136b.

At operation 248, AI management system 110 deploys the retrained second foundation AI models to second AI agents 132b executing on the second entity system 130b to execute the second task 138b. For example, these second AI agents 132b may execute their respective sub-tasks to complete the execution of the second task 138b. Upon deployment, AI management system 110 may monitor the task executions by the second AI agents 132b. The deployment of these retrained second foundation AI models may be via one or more APIs 120 associated with AI management system 110.

At operation 250, AI management system 110 receives, from the second entity system 130b, execution results of the second task 138b by the second AI agents 132b. The execution results may be received via one or more APIs 120 associated with AI management system 110. Method 200 then proceeds to operation 252.

At operation 252, AI management system 110 determines whether the performance of the second AI agent 132b (if only one AI agent 132 is required) or any second AI agent 132b (if more than one AI agent 132 are required) does not meet criteria.

If the performance of the second AI agent 132b (if only one AI agent 132 is required) or all second AI agents 132b (if more than one AI agent 132 are required) meets the criteria, method 200 ends at operation 254.

If the performance of the second AI agent 132b (if only one AI agent 132 is required) or any second AI agent 132b (if more than one AI agent 132 are required) does not meet criteria, method 200 may proceed two separate operation flows.

In one operation flow, at operation 256, AI management system 110 deactivates the second AI agent 132b from executing on the second entity system 130b. Method 200 then ends at operation 264.

In another operation flow, at operation 258, AI management system 110 loads two or more foundation AI models 116 among the plurality of foundation AI models 116 from the memory 114 based on the second task 138b. These two or more foundation AI models 116 would enable a coordinated execution of the second task 138b by multiple AI agents 132 based on a consensus mechanism.

At operation 260, AI management system 110 retrains the two or more foundation AI models 116 by updating model parameters of each of the two or more foundation AI models 116 based on the second set of training data 136b.

At operation 262, AI management system 110 deploys the retrained two or more AI foundation models 116 to two or more AI agents 132 executing on the second entity system 130b to execute the second task 138b. The deployment may be via one or more APIs 120 associated with AI management system 110. The second AI agent 132b and the two or more AI agents 132 may use a consensus mechanism to finalize execution results of the second task 138b. For example, the execution result that has the most consensus among these AI agents 132 may be used as the final execution result for the second task 138b.

Method 200 then ends at operation 264.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated with another system or certain features may be omitted or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “operation for” are explicitly used in the particular claim.

1. A system, comprising:
a memory operable to store:
a plurality of foundation artificial intelligence (AI) models; and
a processor, operably coupled to the memory, and configured to:
receive, from a first entity system, a first request to execute a first task and a first set of training data associated with the first task, wherein the first set of training data includes data samples related to the first task and their respective labels categorizing the data samples with respect to the first task;
load from the memory a first foundation AI model from among the plurality of foundation AI models based at least in part upon first task metadata of the first task, wherein:
the first task metadata comprises at least a first detailed description of the first task, a first parameter of the first task, and a first type of the first task,
the first foundation AI model is selected based on the first task metadata,
the first foundation AI model was trained to execute tasks of the first type, and
the first foundation AI model comprises a plurality of first model parameters;
retrain the first foundation AI model by updating the plurality of first model parameters based at least in part upon the first set of training data;
deploy the retrained first foundation AI model to a first AI agent executing on the first entity system to execute the first task;
receive, from a second entity system, a second request to execute a second task separate from the first task and a second set of training data associated with the second task, wherein the second set of training data includes data samples related to the second task and their respective labels categorizing the data samples with respect to the second task;
load from the memory a second foundation AI model from among the plurality of foundation AI models based at least in part upon second task metadata of the second task, wherein:
the second task metadata comprises at least a second detailed description of the second task, a second parameter of the second task, and a second type of the second task,
the second foundation AI model is selected based on the second task metadata,
the second foundation AI model was trained to execute tasks of the second type, and
the second foundation AI model comprises a plurality of second model parameters;
retrain the second foundation AI model by updating the plurality of second model parameters based at least in part upon the second set of training data; and
deploy the retrained second foundation AI model to a second AI agent executing on the second entity system to execute the second task.

2. The system of claim 1, wherein the processor is further configured to:
determine that executing the first task requires executing a third task by a third AI agent executing on the first entity system;
access, from the first entity system, a third set of training data associated with the third task;
load from the memory a third foundation AI model from among the plurality of foundation AI models based at least in part upon third task metadata of the third task, wherein:
the third task metadata comprises at least a third detailed description of the third task, a third parameter of the third task, and a third type of the third task,
the third foundation AI model was trained to execute tasks associated with the third type, and
the third foundation AI model comprises a plurality of third model parameters;
retrain the third foundation AI model by updating the plurality of third model parameters based at least in part upon the third set of training data; and
deploy the retrained third foundation AI model to the third AI agent to execute the third task.

3. The system of claim 2, wherein the third AI agent is configured to execute the third task using execution results of the first task by the first AI agent.

4. The system of claim 1, wherein the processor is further configured to:
determine that the first task requires a sub-task requiring a third AI agent executing on the first entity system;
load from the memory a third foundation AI model from among the plurality of foundation AI models based at least in part upon task metadata of the sub-task, wherein:
the task metadata comprises a detailed description of the sub-task, a parameter of the sub-task, and a type of the sub-task,
the third foundation AI model was trained to execute tasks of the type associated with the sub-task, and
the third foundation AI model comprises a plurality of third model parameters;
retrain the third foundation AI model by updating the plurality of third model parameters based at least in part upon the first set of training data; and
deploy the retrained third foundation AI model to the third AI agent to execute the sub-task.

5. The system of claim 1, further comprising a plurality of application programming interfaces (APIs), wherein:
receiving the first request or deploying the retrained first foundation AI model to the first AI agent is via a first API among the plurality of APIs; and
receiving the second request or deploying the retrained second foundation AI model to the second AI agent is via a second API among the plurality of APIs.

6. The system of claim 1, wherein the processor is further configured to:
receive, from the first entity system, execution results of the first task by the first AI agent;
determine a performance of the first AI agent does not meet one or more criteria based on the execution results;
load from the memory at least a third foundation AI model and a fourth foundation AI model from among the plurality of foundation AI models based at least in part upon the first task metadata;
retrain the third foundation AI model based at least in part upon the first set of training data;
retrain the fourth foundation AI model based at least in part upon the first set of training data; and
deploy the retrained third foundation AI model to a third AI agent executing on the first entity system and the retrained fourth foundation AI model to a fourth AI agent executing on the first entity system to execute the first task respectively, wherein the first AI agent, third AI agent, and fourth AI agent use a consensus mechanism to finalize execution results of the first task.

7. The system of claim 1, wherein the processor is further configured to:
receive, from the first entity system, execution results of the first task by the first AI agent;
determine a performance of the first AI agent does not meet one or more criteria based on the execution results; and
deactivate the first AI agent from executing on the first entity system.

8. A method, comprising:
receiving, from a first entity system, a first request to execute a first task and a first set of training data associated with the first task, wherein the first set of training data includes data samples related to the first task and their respective labels categorizing the data samples with respect to the first task;
load a first foundation AI model from among a plurality of foundation AI models based at least in part upon first task metadata of the first task, wherein:
the first task metadata comprises at least a first detailed description of the first task, a first parameter of the first task, and a first type of the first task,
the first foundation AI model is selected based on the first task metadata,
the first foundation AI model was trained to execute tasks of the first type, and
the first foundation AI model comprises a plurality of first model parameters;
retrain the first foundation AI model by updating the plurality of first model parameters based at least in part upon the first set of training data;
deploy the retrained first foundation AI model to a first AI agent executing on the first entity system to execute the first task;
receive, from a second entity system, a second request to execute a second task separate from the first task and a second set of training data associated with the second task, wherein the second set of training data includes data samples related to the second task and their respective labels categorizing the data samples with respect to the second task;
load a second foundation AI model from among the plurality of foundation AI models based at least in part upon second task metadata of the second task, wherein:
the second task metadata comprises at least a second detailed description of the second task, a second parameter of the second task, and a second type of the second task,
the second foundation AI model is selected based on the second task metadata,
the second foundation AI model was trained to execute tasks of the second type, and
the second foundation AI model comprises a plurality of second model parameters;
retrain the second foundation AI model by updating the plurality of second model parameters based at least in part upon the second set of training data; and
deploy the retrained second foundation AI model to a second AI agent executing on the second entity system to execute the second task.

9. The method of claim 8, further comprising:
determining that executing the first task requires executing a third task by a third AI agent executing on the first entity system;
accessing, from the first entity system, a third set of training data associated with the third task;
loading a third foundation AI model from among the plurality of foundation AI models based at least in part upon third task metadata of the third task, wherein:
the third task metadata comprises at least a third detailed description of the third task, a third parameter of the third task, and a third type of the third task,
the third foundation AI model was trained to execute tasks associated with the third type, and
the third foundation AI model comprises a plurality of third model parameters;
retraining the third foundation AI model by updating the plurality of third model parameters based at least in part upon the third set of training data; and
deploying the retrained third foundation AI model to the third AI agent to execute the third task.

10. The method of claim 9, wherein the third AI agent is configured to execute the third task using execution results of the first task by the first AI agent.

11. The method of claim 8, further comprising:
determining that the first task requires a sub-task requiring a third AI agent executing on the first entity system;
loading a third foundation AI model from among the plurality of foundation AI models based at least in part upon task metadata of the sub-task, wherein:
the task metadata comprises a detailed description of the sub-task, a parameter of the sub-task, and a type of the sub-task,
the third foundation AI model was trained to execute tasks of the type associated with the sub-task, and
the third foundation AI model comprises a plurality of third model parameters;
retraining the third foundation AI model by updating the plurality of third model parameters based at least in part upon the first set of training data; and
deploying the retrained third foundation AI model to the third AI agent to execute the sub-task.

12. The method of claim 8, wherein:
receiving the first request or deploying the retrained first foundation AI model to the first AI agent is via a first API among a plurality of APIs; and
receiving the second request or deploying the retrained second foundation AI model to the second AI agent is via a second API among the plurality of APIs.

13. The method of claim 8, further comprising:
receiving, from the first entity system, execution results of the first task by the first AI agent;
determining a performance of the first AI agent does not meet one or more criteria based on the execution results;
loading at least a third foundation AI model and a fourth foundation AI model from among the plurality of foundation AI models based at least in part upon the first task metadata;
retraining the third foundation AI model based at least in part upon the first set of training data;
retrain the fourth foundation AI model based at least in part upon the first set of training data; and
deploying the retrained third foundation AI model to a third AI agent executing on the first entity system and the retrained fourth foundation AI model to a fourth AI agent executing on the first entity system to execute the first task respectively, wherein the first AI agent, third AI agent, and fourth AI agent use a consensus mechanism to finalize execution results of the first task.

14. The method of claim 8, further comprising:
receiving, from the first entity system, execution results of the first task by the first AI agent;
determining a performance of the first AI agent does not meet one or more criteria based on the execution results; and
deactivating the first AI agent from executing on the first entity system.

15. A non-transitory computer-readable medium storing instructions that, when executed by one or more processors of a system, cause the one or more processors to:
receive, from a first entity system, a first request to execute a first task and a first set of training data associated with the first task, wherein the first set of training data includes data samples related to the first task and their respective labels categorizing the data samples with respect to the first task;
load a first foundation AI model from among a plurality of foundation AI models based at least in part upon first task metadata of the first task, wherein:
the first task metadata comprises at least a first detailed description of the first task, a first parameter of the first task, and a first type of the first task,
the first foundation AI model is selected based on the first task metadata,
the first foundation AI model was trained to execute tasks of the first type, and
the first foundation AI model comprises a plurality of first model parameters;
retrain the first foundation AI model by updating the plurality of first model parameters based at least in part upon the first set of training data;
deploy the retrained first foundation AI model to a first AI agent executing on the first entity system to execute the first task;
receive, from a second entity system, a second request to execute a second task separate from the first task and a second set of training data associated with the second task, wherein the second set of training data includes data samples related to the second task and their respective labels categorizing the data samples with respect to the second task;
load a second foundation AI model from among the plurality of foundation AI models based at least in part upon second task metadata of the second task, wherein:
the second task metadata comprises at least a second detailed description of the second task, a second parameter of the second task, and a second type of the second task,
the second foundation AI model is selected based on the second task metadata,
the second foundation AI model was trained to execute tasks of the second type, and
the second foundation AI model comprises a plurality of second model parameters;
retrain the second foundation AI model by updating the plurality of second model parameters based at least in part upon the second set of training data; and
deploy the retrained second foundation AI model to a second AI agent executing on the second entity system to execute the second task.

16. The non-transitory computer-readable medium of claim 15, wherein the instructions further cause the one or more processors to:
determine that executing the first task requires executing a third task by a third AI agent executing on the first entity system;
access, from the first entity system, a third set of training data associated with the third task;
load a third foundation AI model from among the plurality of foundation AI models based at least in part upon third task metadata of the third task, wherein:
the third task metadata comprises at least a third detailed description of the third task, a third parameter of the third task, and a third type of the third task,
the third foundation AI model was trained to execute tasks associated with the third type, and
the third foundation AI model comprises a plurality of third model parameters;
retrain the third foundation AI model by updating the plurality of third model parameters based at least in part upon the third set of training data; and
deploy the retrained third foundation AI model to the third AI agent to execute the third task.

17. The non-transitory computer-readable medium of claim 16, wherein the third AI agent is configured to execute the third task using execution results of the first task by the first AI agent.

18. The non-transitory computer-readable medium of claim 15, wherein the instructions further cause the one or more processors to:
determine that the first task requires a sub-task requiring a third AI agent executing on the first entity system;
load a third foundation AI model from among the plurality of foundation AI models based at least in part upon task metadata of the sub-task, wherein:
the task metadata comprises a detailed description of the sub-task, a parameter of the sub-task, and a type of the sub-task,
the third foundation AI model was trained to execute tasks of the type associated with the sub-task, and
the third foundation AI model comprises a plurality of third model parameters;
retrain the third foundation AI model by updating the plurality of third model parameters based at least in part upon the first set of training data; and
deploy the retrained third foundation AI model to the third AI agent to execute the sub-task.

19. The non-transitory computer-readable medium of claim 15, wherein the instructions further cause the one or more processors to:
receive, from the first entity system, execution results of the first task by the first AI agent;
determine a performance of the first AI agent does not meet one or more criteria based on the execution results;
load at least a third foundation AI model and a fourth foundation AI model from among the plurality of foundation AI models based at least in part upon the first task metadata;
retrain the third foundation AI model based at least in part upon the first set of training data;
retrain the fourth foundation AI model based at least in part upon the first set of training data; and
deploy the retrained third foundation AI model to a third AI agent executing on the first entity system and the retrained fourth foundation AI model to a fourth AI agent executing on the first entity system to execute the first task respectively, wherein the first AI agent, third AI agent, and fourth AI agent use a consensus mechanism to finalize execution results of the first task.

20. The non-transitory computer-readable medium of claim 15, wherein the instructions further cause the one or more processors to:
receive, from the first entity system, execution results of the first task by the first AI agent;
determine a performance of the first AI agent does not meet one or more criteria based on the execution results; and
deactivate the first AI agent from executing on the first entity system.
